(19) United States
(12) Patent Application Publication
(10) Pub. No.: US 2014/0089670 A1
(43) Pub. Date: Mar. 27, 2014

(54) UNIQUE CODE IN MESSAGE FOR SIGNATURE GENERATION IN ASYMMETRIC CRYPTOGRAPHIC DEVICE

(71) Applicants: Kerry Maletsky, Monument, CO (US); David Durant, Colorado Springs, CO (US); Balaji Badam, Colorado Springs, CO (US); Michael J. Seymour, Colorado Springs, CO (US)

(72) Inventors: Kerry Maletsky, Monument, CO (US); David Durant, Colorado Springs, CO (US); Balaji Badam, Colorado Springs, CO (US); Michael J. Seymour, Colorado Springs, CO (US)

(73) Assignee: Atmel Corporation, San Jose, CA (US)

(21) Appl. No.: 13/628,946

(22) Filed: Sep. 27, 2012

(51) Int. Cl. H04L 9/32

(52) U.S. Cl. 713/176

(57) ABSTRACT

Methods and systems are disclosed for verifying the use of a client device by a host device in a secure system. In one aspect, a method for authenticating a client device includes receiving, by the client device, a message from a host device, accessing, by the client device, a private key and a unique code stored on the client device, where the unique code is different than the private key, generating, by the client device, a digital signature for the message using the private key and the unique code, and providing, by the client device, the digital signature to the host device for verification of the use of the client device by the host device.

### TECHNICAL FIELD

The subject matter of this application is generally related to cryptography.

### BACKGROUND

A system can include a host device and one or more peripheral or client devices that interface to the host device. The client devices may directly connect to the host device or may communicate with the host device using an implementation of a communication path. In some cases, the entity that manufactures the host device may want to ensure that the client devices are authentic devices for use with the host device in the system and not counterfeit or cloned devices produced for use as client devices in the system by an unauthorized third party or cloner. Allowing the use of unauthorized or cloned devices in the system may degrade the performance of the system resulting in a less than satisfactory user experience. In addition, the use of the unauthorized devices in the system can result in revenue losses by the entity as users may purchase the cloned devices in place of authorized devices manufactured by the entity for use in the system. As such, the entity would prefer to avoid this situation by authenticating each client device for use in the system. Unauthenticated client devices would not be accepted for use by the host device in the system.

### SUMMARY

Elliptic curve cryptographic systems can utilize public key mechanisms that are based on elliptic curves over finite fields. A digital signature algorithm (DSA) can be used in an elliptic curve based public key cryptographic system. An Elliptic Curve Digital Signature Algorithm (ECDSA) is the elliptic curve analogue of the DSA. The ECDSA can be part of a signature scheme used by a trusted certification authority to sign certificates that can bind together a device and its public key. The signature schemes can provide data origin authentication, data integrity, and non-repudiation.

A signature scheme can be considered secure if an adversary or attacker cannot forge the signature. Even if the adversary obtains the signature of a message from a legitimate signer, the adversary would then be unable to produce a valid signature for any new message. The use of a private key in a signature generation process can provide one level of defense against an attacker in a secure system. However, if an attacker were able to obtain a legitimate private key, the attacker may be able to generate a signature or perform other computations that would allow the attacker to operate in and access the secure system.

A host device can implement one or more levels of defense against an attacker. An additional level of defense may include the use of a unique code as an extension to the message signed by the signer or client device using a digital signature algorithm (e.g., ECDSA signature generation). The client device and the host device can belong to or be produced by the same entity. The unique code is assigned to the entity and included in each calculation performed by the host and client devices. The host device, having knowledge of the public key and the unique code, can verify the received signed message using a signature verification process (e.g., ECDSA signature verification). Signed messages that do not include the unique code will not be verified and the client device will therefore not be accepted by the host device for use in the secure system. This verification process can eliminate the use of fraudulent or cloned client devices in the secure system.

In one implementation, a system and method are provided for including a unique code in a digital signature. In general, in one aspect, a method for authenticating a client device is provided. The method includes receiving, by the client device, a message from a host device, accessing, by the client device, a private key and a unique code stored on the client device, where the unique code is different than the private key, generating, by the client device, a digital signature for the message using the private key and the unique code, and providing, by the client device, the digital signature to the host device for verification of the use of the client device by the host device.

The method can include one or more of the following features. The verification of the use of the client device by the host device includes determining that the digital signature was computed using a unique code stored on the host device. The unique code stored on the client device and the unique code stored on the host device are associated with a group of authorized entities. An Elliptic Curve Digital Signature Algorithm (ECDSA) is used to generate, by the client device, the digital signature for the message using the private key and the unique code, and verification of the use of the client device by the host device further includes using the ECDSA. The method further includes receiving, by the client device, a request for information from the host device, and providing, by the client device, the requested information to the host device, where verification of the use of the client device by the host device further includes using the received requested information. The unique code stored on the client device is appended to the received message prior to the generating, by the client device, of the digital signature for the received message using the private key and the unique code. Generating the digital signature for the message further includes computing a message digest using a hash function and where the unique code stored on the client device is appended to the message digest. The hash function uses a Secure Hash Algorithm (SHA).

In general, in another aspect, a method for authenticating a client device is provided. The method includes providing, by a host device, a message to the client device, receiving, by the host device, a digital signature for the message, where the digital signature is generated using a private key and a unique code different than the private key, determining, by the host device, that the digital signature was computed using a unique code stored on the host device, and verifying, by the host device, the use of the client device based on determining that the digital signature was computed using the unique code stored on the host device.

The method can include one or more of the following features. The unique code stored on the client device and the unique code stored on the host device are associated with a group of authorized entities. The client device uses an Elliptic Curve Digital Signature Algorithm (ECDSA) to generate the digital signature for the message using the private key and the unique code, and verifying, by the host device, the use of the client device further comprises using the ECDSA. The method further includes requesting, by the host device, information from the client device, and receiving, by the host device, the requested information from the client device, where verifying, by the host device, of the use of the client device is partially based on the received requested information. The unique code in the digital signature is appended to the message. The digital signature for the message includes a message digest and the unique code in the digital signature is appended to the message digest.

In general, in one aspect, a system for authenticating a client device is provided. The system includes a client device including an authentication component, and a host device including an authentication module. Verifying use of the client device in the system by the host device includes providing, by the host device, a message to the client device, accessing, by the client device, a private key and a unique code stored in the authentication component, wherein the unique code is different than the private key, generating, by the client device, a digital signature for the received message using the private key and the unique code, providing, by the client device, the digital signature to the host device, determining, by the host device, that the digital signature was computed using a unique code stored in the host device, and verifying, by the host device using the authentication module, the use of the client device in the system based on determining that the digital signature was computed using the unique code stored in the host device.

The system can include one or more of the following features. The unique code stored in the client device and the unique code stored in the host device are associated with a group of authorized entities. The unique code stored in the host device is programmed into non-volatile read-only memory an appropriate phase of the production of the host device. The unique code stored in the authentication component is programmed into internal memory included in the authentication component at the time of manufacture of the authentication component.

Particular implementations of the subject matter described in this specification can be implemented so as to realize one or more of the following advantages. For example, the use of multiple levels of defense against an attacker can prevent the use of fraudulent or cloned client devices in a system. The entity can ensure that the client devices provided by the entity or approved for use by the entity are the only client devices that will work in the system. This allows the entity to control the performance and user experience with the system as well as to control their profitability. The use of a unique code fabricated in at least one component included in each client and host device provides an additional level of security. In general, duplicating the functions of a cryptography component can be complex and expensive. Since the cryptography component may be expensive to duplicate, an attacker may prefer to purchase an off-the-shelf component that performs the functions. However, the unchangeable unique code included in the off-the-shelf component will be different than the unique code used in the system the attacker is trying to clone, rendering the off-the-shelf component useless in the system.

### DESCRIPTION OF DRAWINGS

FIG. 1 is a block diagram of an example implementation of a public key cryptographic system that incorporates a unique code into a DSA.

FIG. 2 is a flow diagram of an example implementation of a process for signing a message that includes a unique code.

FIG. 3 is a flow diagram of an example implementation of a process for verifying a signed message that includes a unique code.

Like reference symbols in the various drawings indicate like elements.

### DETAILED DESCRIPTION

### Example Cryptographic System & Process

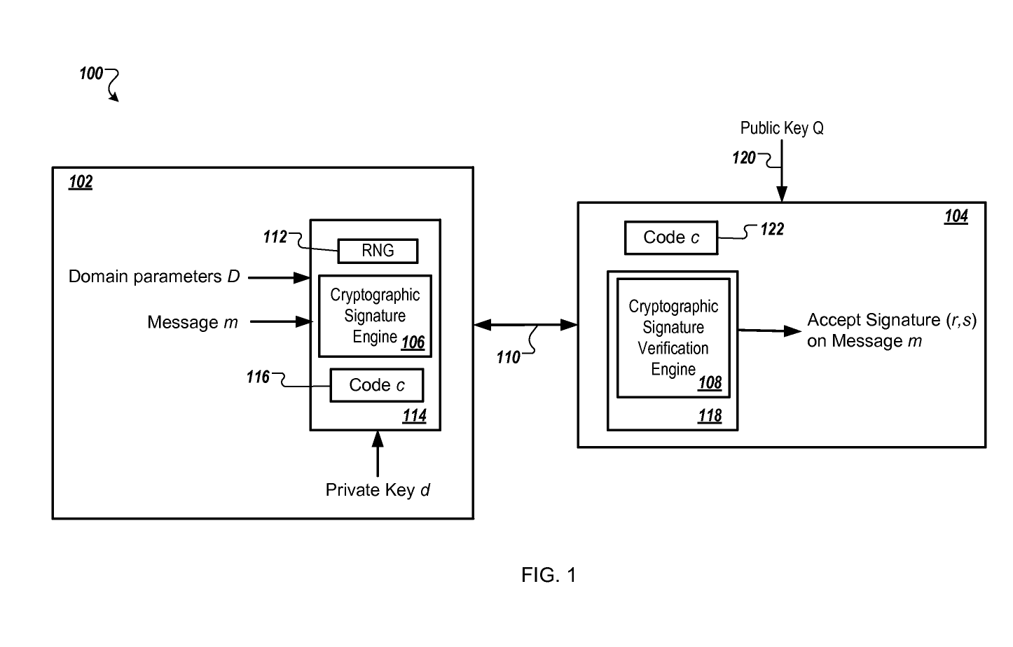

FIG. 1 is a block diagram of an example implementation of a public key cryptographic system 100 that incorporates a unique code c into a DSA. The system 100 includes device 102 and device 104. In some implementations, the device 104 can be considered a host device and the device 102 can be considered a client device. The device 104 can be any device capable of performing cryptographic processes, including but not limited to: a personal computer, a mobile device (e.g., a mobile phone), an email device, a game console, a personal digital assistant (PDA), etc. The device 102 can be any device capable of performing cryptographic processes that can be used as a peripheral or accessory with device 104, including but not limited to: cartridges, probes, controllers, battery packs, chargers, etc. For example, the device 104 can be included in a printer and the device 102 can be included in a cartridge for use in the printer. In another example, the device 104 can be included in a gaming system and the device 102 can be included in a handheld device for input to the gaming system. In another example, the device 104 can be included in a mobile device and the device 102 can be included in a battery for the mobile device.

In the example system 100, devices 102 and 104 can communicate with each other over an unsecured channel 110. For example, the device 102 can send a message over the unsecured channel 110 to the device 104 where the devices 102 and 104 are capable of performing cryptographic processes. The unsecured channel 110 can be any communication medium, including but not limited to: radio frequency (RF) carriers, optical paths, circuit paths, networks (e.g., the Internet), wireless communication paths, etc.

In some implementations, the device 102 includes an authentication component 114 that includes cryptographic signature engine 106, a random number generator 112 and an internal memory 116 that stores a unique code c. The random number generator can generate true random numbers (e.g., generated from a physical process) or pseudo random numbers (e.g., generated from an algorithm). In other implementations, the device 102 can receive the random numbers through an interface or the random numbers can be stored on the device 102 (e.g., in the internal memory 116).

The cryptographic signature engine 106 generates or encrypts digital signatures to send to the device 104 for authentication. The device 104 includes authentication capabilities. In the example system 100, the authentication capabilities can be included in an authentication module 118 that includes a cryptographic signature verification engine 108 for decrypting or verifying the digital signatures received from the device 102. In some implementations, the devices 102 and 104 can include authentication components and/ or modules that can each include both cryptographic signature engine 106 and cryptographic signature verification engine 108 for bi-directional communication. In the example shown, the devices 102 and 104 can perform a variety of cryptographic processes, including but not limited to: elliptic curve encryption/decryption, digital signature generation and authentication, and elliptic curve digital signature generation and authentication.

### Elliptic Curve Digital Signature Algorithm (ECDSA)

In some implementations, a signature scheme (e.g., ECDSA) can include four algorithms that involve both the device 102 and the device 104.

The first algorithm can be a domain parameter generation algorithm that can generate a set, D, of domain parameters. Domain parameters describe an elliptic curve, E, defined over a finite field, F_{q}, a base point P ∈ E(F_{q}), and its order n. The domain parameters D can include, but are not limited to, the following parameters: q, the field order; FR, an indication of the representation used for the elements of a finite field, F_{q}; two coefficients a, b ∈ F_{q} that define the equation of the elliptic curve E over F_{q} (e.g., in the case of a prime field, a and b in equation y²=x³+ax+b); a point, P, in E(F_{q}); the order, n, of P; and a cofactor, h, where h=#E(F_{q}) /n, and #E(F_{q}) is the number of points in the elliptic curve, E.

The second algorithm can be a key generation algorithm that can take a set of domain parameters D, and generate a key pair (e.g., a public key Q, a private key d).

The third algorithm can be a signature generation algorithm that can take as input a set of domain parameters D, a private key d, and a message m, and produce a signature (r,s).

The fourth algorithm can be a signature verification algorithm and can take as inputs a set of domain parameters D, a public key Q, a message m, and a signature (r,s), and can accept or reject the signature (r,s). For example, device 104, the recipient, can acquire the public key Q, from device 102 by way of an authenticated channel 120.

The devices 102 and 104 can perform any or all of the four algorithms. The devices 102 and 104 can perform the four algorithms using authentication component 114 and authentication module 118 along with additional microprocessors and/or microcontrollers that can be included in either or both of the devices 102 and 104. In some implementations, the authentication module 118 can be implemented using the same component as the authentication component 114 where each authentication component can include both an encryption engine and a decryption engine for performing signature generation and validation.

In an implementation of an ECDSA, with reference to FIG. 1, a recipient (e.g., device 104) can send a message m to a sender (e.g., device 102). The sender (e.g., device 102) can generate a signature and transmit it to the recipient (e.g., device 104) via an unsecured channel (e.g., the unsecured channel 110). The ECDSA signature generation algorithm takes as its inputs domain parameters D, a private key d, and the message m, and outputs a signature (r,s). The recipient (e.g., device 104) can then verify the received signature (r,s). The ECDSA signature verification algorithm takes as its inputs domain parameters D, a public key Q, the message m, and the received signature (r,s), and outputs an acceptance or rejection of the signature (r,s).

The sender (e.g., device 102) can select a random number, k, from the interval [1, (n-1)] that can be generated by a random number generator (e.g., random number generator 112) where, n, is the order of the base point P, on the elliptic curve E. The sender can compute k.P=(x₁, y₁), where (x₁, y₁) is a point on the elliptic curve E. Point coordinate x₁ can be converted to an integer, x̅1̅. The sender can compute r= x̅1̅ mod n, where mod is a modulus operator. If r is equal to zero, the sender begins the signature generation process again and selects a random number k. If r is not equal to zero, the sender can compute a message digest e=H(m), using a cryptographic hash function H, where the message digest e can serve as a short fingerprint of the message m. The sender can then compute s=k⁻¹*(e+d*r) mod n. If s is equal to zero, the sender begins the signature generation process again and selects another random number k. If s is not equal to zero, the sender can transmit signature (r,s) to the recipient.

The recipient (e.g., device 104) can perform an ECDSA signature verification process in order to verify the received signature (r, s), and then either accept the signature or reject the signature. The recipient can acquire the public key Q, and the domain parameters D from the sender (e.g., device 102) by way of an authenticated channel 120. In some cases, the recipient can acquire the public key Q from a certificate where the ECDSA can be part of a signature scheme used by a trusted certification authority to sign certificates that can bind together a device and its public key Q. For example, the recipient can interrogate the authentication component 114 in order to obtain the required parameters needed for the signature verification process. The recipient can verify that r and s are integers in the interval [1, (n-1)]. If either r or s, or both r and s are not in the interval [1, (n-1)], the verification will fail and the recipient can reject the signature.

If r and s are in the interval [1, (n-1)], the recipient can then compute the message digest e=H(m). Next, the recipient can compute a value, w=s⁻¹ mod n. The recipient can compute values, u₁ and u₂, where u₁=e*w mod n, and u₂=r*w mod n. The recipient can then compute a value, X, where X=u₁.P+u₂.Q. If X is equal to infinity, the recipient can reject the signature. If X is not equal to infinity, the recipient can convert the x coordinate (x₁) of the point, X, to an integer, x̅1̅. The recipient can compute a value, v, where v= x̅1̅ mod n. If v equals r, the recipient can accept the signature. If v is not equal to r, the recipient can reject the signature. The recipient then ends the signature verification process.

### Hash Algorithm and Message Digest

Some implementations of the ECDSA can use a Secure Hash Algorithm (SHA) in the cryptographic hash function H. The SHA is a cryptographic hash function published by the National Institute of Standards and Technology (NIST) as a U.S. Federal Information Processing Standard (FIPS). The hash function, H(m), can operate on an arbitrary length message m, and return a fixed-length hash value e, which can be referred to as a message digest. For example, SHA-2 is a set of four hash functions: SHA-224, SHA-256, SHA-384, SHA-512 with message digests that are 224, 256, 384, and 512 bits in length, respectively. In addition, SHA-256 and SHA-512 use 32-bit words and 64-bit words, respectively. In an example use of the SHA-256, when a message of any length is input to the SHA-256, the SHA-256 generates a 256-bit message digest, e. As described above, the message digest e can be used to compute the signature for the message. The bitlength of the message digest e used in an ECDSA may be truncated if the bitlength of the calculated message digest exceeds the bitlength of n, the order of the base point P. The SHA can be considered secure because it is designed to be computationally infeasible to recover a message corresponding to a given message digest, or to find two different messages which produce the same message digest.

The unique code c can be combined with the message m for incorporation into the signature prior to an asymmetric computation. In some implementations, a unique code c can be added to the message m by the sender (e.g., device 102) prior to the generation of the signature (r,s) by the ECDSA. The unique code c can be added to the message m as an extension of the message by, for example, appending the unique code c to the message m. In some implementations, the unique code c can be added to the message digest (e.g., appended to the fixed-length hash value e generated by the ECDSA). In some implementations, the unique code c can be added to the message m by, for example, prepending the unique code c to the message m. In some implementations, the unique code c can be inserted in the middle of the message m. In some implementations, the unique code c can be combined with the message digest and the combination can be provided as the input to the cryptographic hash function H, in order to compute an additional message digest for further use in generating the digital signature.

### Implementation of Unique Code in the Client and Host Devices

In an implementation of an ECDSA that incorporates a unique code c, with reference to FIG. 1, a recipient (e.g., device 104) can send a message m to a sender (e.g., device 102). The sender (e.g., device 102) can generate a signature that includes the unique code c and transmit the signature to the recipient (e.g., device 104) via an unsecured channel (e.g., the unsecured channel 110). The ECDSA signature generation algorithm takes as its inputs domain parameters D, a private key d, the unique code c and the message m, and outputs a signature (r,s). The recipient (e.g., device 104) can then verify the received signature (r,s). The ECDSA signature verification algorithm takes as its inputs domain parameters D, a public key Q, the message m, the unique code c, and the received signature (r,s), and outputs an acceptance or rejection of the signature (r,s).

As previously described, the sender (e.g., device 102) when performing the signature generation process can compute a message digest e=H(m), using a cryptographic hash function H, where the message digest e can serve as a short fingerprint of the message m. In some implementations, the unique code c can be appended to the message digest where e=(concat(c, (H(m)). In this case, the message digest e is the same size or smaller than n, the order of the base point P. In some implementations, the unique code c can be appended to the message where e=H(concat(c, m)).

The sender can then compute s=k⁻¹*(e+d*r) mod n. If s is equal to zero, the sender begins the signature generation process again and selects another random number k. If s is not equal to zero, the sender can transmit signature (r, s) to the recipient.

The recipient (e.g., device 104) can perform an ECDSA signature verification process in order to verify the received signature (r, s), and then either accept the signature or reject the signature. The recipient can acquire the public key Q, and the domain parameters D from the sender (e.g., device 102) by way of an authenticated channel 120. For example, the recipient can interrogate the authentication component 114 in order to obtain the required parameters needed for the signature verification process. The recipient can verify that r and s are integers in the interval [1, (n-1)]. If either r or s, or both r and s are not in the interval [1, (n-1)], the verification will fail and the recipient can reject the signature.

If r and s are in the interval [1, (n-1)], the recipient can then compute the message digest e as the recipient knows the unique code c. If the recipient does not successfully compute the message digest e (e.g., the unique code known by the recipient may be different than the unique code used to compute the message digest e) the verification will fail and the recipient can reject the signature. Next, the recipient can compute a value, w=s⁻¹ mod n. The recipient can compute values, u₁ and u₂, where u₁=e*w mod n, and u₂=r*w mod n. The recipient can then compute a value, X, where X=u₁.P+u₂.Q. If X is equal to infinity, the recipient can reject the signature. If X is not equal to infinity, the recipient can convert the x coordinate (x₁) of the point, X, to an integer, x̅1̅. The recipient can compute a value, v, where v= x̅1̅ mod n. If v equals r, the recipient can accept the signature. If v is not equal to r, the recipient can reject the signature. The recipient then ends the signature verification process.

Although the cryptographic processes described are related to elliptic curves, the disclosed implementations can be used with any cryptographic processes that perform field operations where it is desirable to authenticate the use of a client device with a particular host device. For example, the cryptographic processes described can be applied to a key exchange/agreement/management process between a client device and a host device, where the actual key exchange/agreement/management action results in the authentication of the client device by the host device when the client device and the host device use the same unique code within the process.

In some implementations, the system 100 can use asymmetric key algorithms (e.g., RSA) allowing the authentication of a message. The cryptographic signature engine 106 can generate a digital signature of the message using a private key. The cryptographic signature verification engine 108 can then verify the digital signature of the message using a public key. In some implementations, the hash of the message can be encrypted for signature verification purposes.

The unique code c can be a number assigned to an entity associated with both the sender and the recipient. In some cases, the unique code is assigned to only one entity. For example, an entity that manufactures and/or sells the device 102 and the device 104 can be assigned a number for the unique code c. In some cases, the unique code is assigned to each entity in a group of authorized entities that can manufacture and/or sell the device 102 and the device 104.

The unique code c can be programmed into each of the devices 102 and 104. For example, referring to the system 100, the unique code c can be programmed into the internal memory 116 included in the authentication component 114 on the device 102. The internal memory 116 can be non-volatile memory or any other type of persistent memory. The implementation of the internal memory 116 is such that the internal memory 116 cannot be otherwise altered or reprogrammed once programmed during the manufacture of the authentication component 114. In addition, the unique code c can be programmed into internal memory 122 included in the device 104, which can also be implemented as non-volatile memory or any other type of persistent memory that cannot be otherwise altered or reprogrammed once programmed during the manufacture of the device 104. In another example, the unique code c can be built into a component included in the device 104.

As described, the unique code c is not alterable after the manufacture of the devices 102 and 104. As such, a component provider can fabricate a certain number of components for an entity that include the unique code c for the entity. For example, the provider of the authentication component 114 can fabricate a specific number of the authentication components for use in client devices (e.g., device 102) by the entity. The entity may then manufacture host devices (e.g., device 104) to also include the unique code c using, for example, one of the previously described implementations. The component provider can supply the entity with the specific authentication components for inclusion in their client devices. In order to prevent cloning of a client device by a third party, the component provider will only provide the entity with the specific authentication components that include the stored unique code c. The component provider would require specific written instructions from the entity in order to provide the specific authentication components that include the unique code c to any party other than the entity itself.

In some cases, the entity may have multiple clients that can communicate with a single host. In this case, each client can include an authentication component programmed with the unique code c allowing the host device to authenticate each client device. In some cases, the entity may have a single client device that can communicate with multiple host devices. In this case, each host device is capable of authenticating the client device. In some cases, the entity may have multiple client devices that can communicate with multiple host devices. In this case, each client device can include an authentication component programmed with the unique code c allowing each host device the ability to authenticate each client device.

In some cases, the unique code c may be publically known. However, the public knowledge of the unique code c does not compromise the security of the system 100 as a third party would be unable to otherwise program a generic device to include the unique code c as this programming is done at any point during the manufacturing, factory initialization, personalization, distribution or other appropriate phase of the production of the device in either internal memory or another location on the device that cannot be reprogrammed.

For example, if an attacker were to obtain a legitimate private key value, the attacker may be able to program any off-the-shelf authentication component in order to make it perform the same as any other off-the-shelf authentication component. The attacker could purchase a standard version of the authentication component (e.g., from a distributer of the off-the-shelf component) for use in a client device that can be used in system with a host device developed by a particular entity. In addition or alternatively, a factory can fabricate each authentication component with the unique code (e.g., the authentication component is programmed at the factory with the unique code for the particular entity). The resultant population of these specific authentication components can be segregated into one or more separate pools for use only by the entity associated with the unique code. The factory can provide these segregated components to the associated entity or to a third party approved by the entity. The factory will not provide the segregated components to a distributer for sale as off-the-shelf components.

Client devices that include an authentication component programmed or fabricated at the factory with the unique code for the particular entity can generate a signature or other computation result that will be authenticated and utilized by the host device in a secure system. Client devices that include a standard authentication component purchased off-the-shelf from a distributer or client devices that acquire an authentication component configured for a different entity (e.g., the authentication component is programmed with a unique code that is not associated with the entity that is providing the host device) would not be able to generate a signature for acceptance by the host device in the secure system even with the knowledge of and use of a legitimate private key for the secure system.

An authentication component can be optimized to perform the necessary authentication functions for a general purpose client device. Software can be written for the general purpose client device that includes capabilities that are not necessary for secure authentication. If an attacker or unauthorized third party is unable to include an authentication component in a cloned client device, the third party would then have to write software for a general purpose client device or create additional hardware for inclusion in a general purpose client device that exactly mimics the operation of the authentication component in order for the general purpose client device to be used in the system with the host device. This would take a significant amount of time and effort on the part of the third party. In addition, the cloned client device would need to include a processing element capable of calculating the elliptic curve cryptographic (ECC) math operations efficiently and in an acceptable amount of time. This additional constraint may force the third party to spend more money on the cloned client device in order to include the authentication capabilities than they would prefer to spend resulting in a reduced profit margin for the cloned client device for the third party.

The segregation of the entire population of authentication components with a specific unique code into one or more separate pools for use only by the entity associated with the unique code can limit the misappropriation of authentication components to unauthorized third parties which may use the authentication components in fraudulent or cloned devices.

For example, a client device is a battery and the host device is a mobile communication device. The battery includes an authentication component that includes a unique code for the entity that manufactures both the mobile communication device and the battery. The mobile communication device includes the unique code programmed into non-volatile read-only memory included in the mobile communication device. A user plugs the battery into the mobile communication device and turns the device on. The mobile communication device interrogates the battery to determine it is connected. The mobile communication device generates a random message and sends it to the battery. The battery receives the message and provides the message back to the mobile communication device along with a digital signature that is generated using the unique code appended to the message or to the digest of the message. The mobile communication device interrogates the authentication component included in the battery to obtain the required details (e.g., the domain parameters) in order to perform the signature verification process. If the mobile communication device verifies the signature, the user will be able to operate the mobile communication device. In some cases, if the mobile communication device does not verify the signature, the user will not be able to further operate the mobile communication device (e.g., the device will lock and become inoperable). In other cases, if the mobile communication device does not verify the signature, the user may have limited use of the mobile communications device (e.g., use of certain device features and not all of the device features).

### Signing a Message That Includes a Unique Code

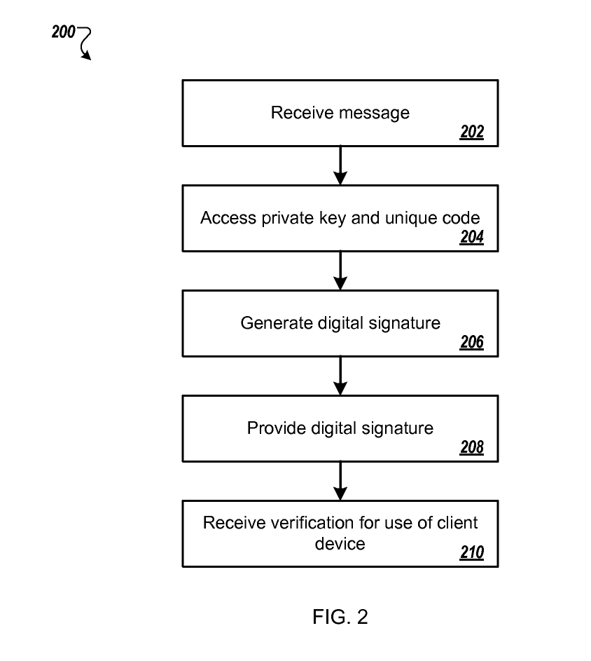

FIG. 2 is a flow diagram of an example implementation of a process 200 for signing a message that includes a unique code. The process 200 can be performed in an implementation of a public key cryptographic system (e.g., system 100 in FIG. 1). The process 200 can be performed in an example system that includes a host device and a client device. The example system can be one of the systems described in this document.

The process 200 begins when a message is received (step 202). For example, a host device can interrogate a client device when power is applied to the host device. The client device then receives an interrogation message from the host device. The interrogation message can check for the presence of the client device by requesting particular information about the client device. A private key and a unique code, different than the private key, are accessed (step 204) and a digital signature is generated (206). For example, the client device can access the private key and the unique code and use the private key to generate the digital signature further including the unique code with the digital signature. The digital signature is provided (step 208). For example, the client device can provide the generated digital signature that includes the unique code to the host device. Verification of the use of the client device is received (step 210). For example, the host device can verify the use of the client device by the host device in the cryptographic system and the client device receives this verification from the host device.

In some implementations, the host device computes a hash of the interrogation message m using a hash function, H(m). In this case, the client device receives the hash of the interrogation message m from the host device. The client device can then access a private key and a unique code, different than the private key, in order to generate a digital signature for the hash of the interrogation message m that can be provided to the host device. For example, the client device can append the unique code to the hash of the interrogation message m when generating the digital signature.

### Verifying a Message That Includes a Unique Code

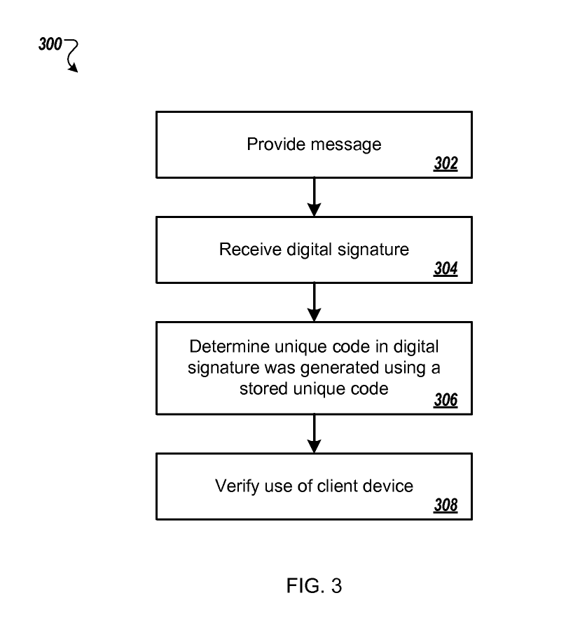

FIG. 3 is a flow diagram of an example implementation of a process 300 for verifying a signed message that includes a unique code. The process 300 can be performed in an implementation of a public key cryptographic system (e.g., system 100 in FIG. 1). The process 300 can be performed in an example system that includes a host device and a client device. The example system can be one of the systems described in this document.

The process 300 begins when a message is provided (step 302). For example, a host device can interrogate a client device when power is applied to the host device. The host device provides an interrogation message to the client device. The interrogation message can check for the presence of the client device by requesting particular information about the client device. A digital signature is received (step 304). For example, the client device can generate the digital signature using a private key and a unique code appended to the interrogation message or to the digest of the interrogation message. The host device receives the digital signature. It is determined that the unique code included in the digital signature was generated using a stored unique code (step 306). For example, the host device can determine that the unique code included in the received digital signature matches a unique code stored in memory on the host device. The use of the client device is verified (step 308). For example, the host device can verify the use of the client device by the host device in the cryptographic system based on determining that the received digital signature as generated using the unique code stored in memory on the host device.

In some implementations, the digital signature generation and verification processes can be used in a system that implements peer-to-peer transactions. For example, in a peer-to-peer process, at any given point in time one of the peers serves as a host device and one of the peers serves as a client device. At another given point in time, the two devices may switch functions where the device that served as the client device would now serve as the host device and the device that served as the host device would now serve as the client device. In this implementation, each device would be capable of generating and authenticating a digital signature.

In some implementations, the host device and the client device include real time clocks, where the client device signs a message that is the current time. The current time message may not be received from the host device as the host device can independently determine if it is willing to accept the message regarding the time value used by the client device. If accepted, the host device then verifies the use of the client device.

In some implementations, the client device includes persistent information where many host devices can use the client device at many different times. As such, the receipt of a message from the host device by the client device may not start the interrogation process. For example, the client can generate a certificate of the client keys with a unique code appended to the certificate.

While this document contains many specific implementation details, these should not be construed as limitations on the scope what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination. Logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method for authenticating a client device, the method comprising:
receiving, by the client device, a message from a host device;
accessing, by the client device, a private key and a unique code stored on the client device, wherein the unique code is different than the private key;
generating, by the client device, a digital signature for the message using the private key and the unique code; and
providing, by the client device, the digital signature to the host device for verification of the use of the client device by the host device.

2. The method of claim 1, wherein verification of the use of the client device by the host device comprises:
determining that the digital signature was computed using a unique code stored on the host device.

3. The method of claim 2, wherein the unique code stored on the client device and the unique code stored on the host device are associated with a group of authorized entities.

4. The method of claim 2, wherein an Elliptic Curve Digital Signature Algorithm (ECDSA) is used to generate, by the client device, the digital signature for the message using the private key and the unique code, and verification of the use of the client device by the host device further comprises using the ECDSA.

5. The method of claim 2, further comprising:
receiving, by the client device, a request for information from the host device; and
providing, by the client device, the requested information to the host device, wherein verification of the use of the client device by the host device further comprises using the received requested information.

6. The method of claim 5, wherein the unique code stored on the client device is appended to the received message prior to the generating, by the client device, of the digital signature for the received message using the private key and the unique code.

7. The method of claim 5, wherein generating the digital signature for the message further comprises computing a message digest using a hash function and wherein the unique code stored on the client device is appended to the message digest.

8. The method of claim 7, wherein the hash function uses a Secure Hash Algorithm (SHA).

9. A method for authenticating a client device, the method comprising:
providing, by a host device, a message to the client device;
receiving, by the host device, a digital signature for the message, wherein the digital signature is generated using a private key and a unique code different than the private key;
determining, by the host device, that the digital signature was computed using a unique code stored on the host device; and
verifying, by the host device, the use of the client device based on determining that the digital signature was computed using the unique code stored on the host device.

10. The method of claim 9, wherein the unique code stored on the client device and the unique code stored on the host device are associated with a group of authorized entities.

11. The method of claim 9, wherein the client device uses an Elliptic Curve Digital Signature Algorithm (ECDSA) to generate the digital signature for the message using the private key and the unique code, and verifying, by the host device, the use of the client device further comprises using the ECDSA.

12. The method of claim 9, further comprising:
requesting, by the host device, information from the client device; and
receiving, by the host device, the requested information from the client device, wherein verifying, by the host device, the use of the client device is partially based on the received requested information.

13. The method of claim 12, wherein the unique code in the digital signature is appended to the message.

14. The method of claim 12, wherein the digital signature for the message includes a message digest and the unique code in the digital signature is appended to the message digest.

15. A system comprising:
a client device including an authentication component; and
a host device including an authentication module, wherein verifying use of the client device in the system by the host device comprises:
providing, by the host device, a message to the client device;
accessing, by the client device, a private key and a unique code stored in the authentication component, wherein the unique code is different than the private key;
generating, by the client device, a digital signature for the received message using the private key and the unique code;
providing, by the client device, the digital signature to the host device;
determining, by the host device, that the digital signature was computed using a unique code stored in the host device; and
verifying, by the host device using the authentication module, the use of the client device in the system based on determining that the digital signature was computed using the unique code stored in the host device.

16. The system of claim 15, wherein the unique code stored in the client device and the unique code stored in the host device are associated with a group of authorized entities.

17. The system of claim 16, wherein the unique code stored in the host device is programmed into non-volatile read-only memory at an appropriate phase of production of the host device.

18. The system of claim 16, wherein the unique code stored in the authentication component is programmed into internal memory included in the authentication component at the time of manufacture of the authentication component.
